(19) United States
(12) Patent Application Publication
(10) Pub. No.: US 2023/0063223 A1
(43) Pub. Date: Mar. 2, 2023

(54) Carbon neutral groundwater and rainwater dual irrigation system

(71) Applicant: Bill Baoxun Wang, Mentone, CA (US)

(72) Inventor: Bill Baoxun Wang, Mentone, CA (US)

(21) Appl. No.: 17/458,569

(22) Filed: Aug. 27, 2021

(51) Int. Cl. A01G 25/06; B01D 63/04; B01D 65/02; B01D 71/68; C02F 1/44; C02F 1/00; A01G 25/16; G01N 1/10

(52) U.S. Cl. CPC A01G 25/06; B01D 63/043; B01D 65/02; B01D 71/68; C02F 1/44; C02F 1/008; A01G 25/167; G01N 1/10; C02F 2303/16; C02F 2209/03; C02F 2209/40; C02F 2103/001

(57) ABSTRACT

The present invention is a two-part irrigation system that utilizes both groundwater and rainwater. The first system extracts water from groundwater layers by using extraction pipes filled with nanomilled sand that constantly moves water upwards through capillary action. The second is a rainwater collection and capillary irrigation system. The groundwater irrigation system consists of an external groundwater transport pipe filled with nanomilled sand. This encapsulates an empty internal transport pipe that delivers percolated water. The rainwater irrigation system consists of a collection, storage, filtration, and capillary irrigation system. Rainwater is collected by trays and a water tank, where the water is filtered through a hollow fiber membrane filter. This clean water is used as potable drinking water or for irrigation. The water volume required for irrigation is calculated based on moisture data collected by moisture detection devices. Both systems are solar powered, and are controlled and programmed by the user.

### CROSS-REFERENCE TO RELATED APPLICATIONS

Not Applicable

### STATEMENT REGARDING FEDERALLY SPONSORED RESEARCH OR DEVELOPMENT

Not Applicable

### The Names of the Parties to a Joint Research Agreement

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present invention presents two irrigation methods via groundwater and rainwater that perform its functions in subsurface irrigation. The irrigation system in its entirety broadly encompasses water filtration, generation of potable water, groundwater irrigation, capillary action, nanomilled particle usage, rainwater storage and usage, and automated moisture control data processing using moisture detection devices. The systems cooperate wherein the groundwater irrigation system supplies water to the topsoil by capillary rise that occurs due to nanomilled sand. The rainwater irrigation system assists the prior system by providing irrigation water through distribution pipes and hollow fiber membrane capillaries throughout the soil. More importantly, the use of nanomilled sand for irrigation maximizes the surface area of the particles that holds surface tension. Within this system, percolated water may travel down to recharge groundwater layers in an internal pipe, such as excess rainwater. Also, the rainwater irrigation system can store, filter, and deliver potable water to the residence or for irrigation. The present system uses valves, distribution pipes and hollow fiber membrane capillaries to deliver clean water to large areas of land while minimizing the chances of clogs that form as a result of an excess of contaminants and sediments. The installation process also uses two distinct layers of soil, where compacted soil allows water to be easily transported above, while loose topsoil that plants grow in. By analyzing concurrent environmental conditions at the irrigation sites, the system can determine the best use of water using soil water potential. This automatic system performs its functions based on this water data, which, along with other electrical components, are all solar powered to achieve carbon neutrality.

### Description of Related Art

Water irrigation systems exist in various forms such as above-ground sprinkler irrigation, drip irrigation, and flood irrigation that cover different areas of land. These different systems have vastly different water delivery and absorption efficiencies, and varied effectiveness in preventing the loss of water that had not been absorbed into the soil. The loss of valuable water has a significant effect on areas around the world that suffer from droughts and water shortage issues, which can limit agricultural and urban development with insufficient methods of recycling and reusing water and conserving as much water as possible. The small amounts of water that could be saved and reused from water loss during agricultural irrigation can be reintegrated into existing distribution and processing systems to provide a solution for the existing water shortage problems.

In response to water shortage issues, subsurface irrigation has been shown to be more efficient than above-surface irrigation as the soil is able to absorb the water from below, reducing evapotranspiration, percolation, and runoff losses as a result of being exposed to the elements.

In Brock et al., U.S. Pat. No. 3,819,118, a drip irrigation mechanism was devised to distribute water across an area of farmland and perform irrigation. The system uses a series of capillaries and distribution pipes that are pressurized to ensure the successful delivery of water across all branches of pipes. The invention also includes a simple fix that allowed any blockages to be removed more simply by dealing with separate parts of the distribution systems. This system fails to address the loss of water through evapotranspiration and the inability to distribute water and nutrients adequately according to plant needs.

In Shih, U.S. Pat. No. 6,036,104, the inventor creates a setup that combines both sprinkler and drip irrigation into one system that is able to switch between methods of irrigation quickly without the need for the installation of a new system. The piping are outfitted with sprinkler/drip outputs after a certain distance, which are all controlled automatically through humidity and what the enduser desires. All piping, supported above ground with poles, are connected to an above-ground water tank that has to be recharged. This system does not address the loss of water through evapotranspiration and percolation, and is unable to address the effectiveness of watering with drip irrigation over large areas of land without the need to place large sections of piping close together to accommodate for the lack of area coverage by drip irrigation.

In Wilkes, U.S. Pat. No. 7,690,151 B2, a stackable flower pot that is watered from the top down allows percolated water from the top layers to irrigate the lower layers using drip irrigation. Any water that reaches the bottom of the stack will be recycled into the potting system by flowing back up into certain pots with wicks. This setup utilizes a water-efficient setup that is ideal for small-scale gardening, but will be impossible to translate over to a larger field that requires a more complex circulation system. The system also utilizes capillary action to delivery water vertically against gravity. Such a system is similar to the present invention in that percolated water may be recycled back into the irrigation system.

In Hansen, U.S. Pat. No. 10,231,392 B2, a new flower pot irrigation system was introduced with a water basin that is able to constantly deliver water through wicks to the pots above, making transportation and irrigation easier in general. This ensures minimal management costs that allow plants to travel further distances. However, this system is temporary, and can be used in small scale planting by the end user as well as the retailer, as the plants will need to eventually be repotted. Evaporation of the water can also be prevented by covering up the water basin, but it cannot be transferred to a larger area of land.

In Sternberg, U.S. Pat. No. 10,264,741 B2, a subsurface irrigation system with two layers of porous soil allows water to travel upwards via capillary action to moisten the soil above, giving water to the roots of plants above. The land is enclosed by a water impermeable layer that traps all naturally percolating water and rain/snow. There is also a built in drainage pipe if water is unable to completely be absorbed and oversaturates the soil. The drainage system may recycle the water back into the water basin, which further alleviates problems with percolation loss. However, the system requires the user to displace all of the soil that the system covers in order to install the waterproof barrier underneath the subsoil.

In Lu, U.S. Pat. No. 10,548,268 B1, several new inventive systems for irrigation were created for large fields, flower pots, and the possibility of integrating these new systems in the future for space colonization in which the system is still able to behave. With a complicated system of piping and valve controls that detect moisture levels and to prevent as much water loss as possible, the system is able to use the capillary action of soil in different variations with a moisture diffuser that slowly delivers water without the need for human intervention. Solar power makes the system very power-efficient as many processes are automated. The bi-directional flow design is proposed to eliminate percolation and evapotranspiration loss, as the system is designed to deliver water according to plant needs throughout its growth. Its water diffuser probe mechanism is also effective in controlling water flow. This complicated system is able to resolve a number of concerns with modern irrigation techniques.

In Leung et al., U.S. Pat. No. 10,980,196 B2, an irrigation system is created based on surface level permeation irrigation using specialized pipes, combined with fertilizer and moisture detection devices, allowing the user to control water usage and prevent water loss. The recycling system between the planters and the water tank are constantly cycled and may be stopped by an automatic valve. This piping system is water efficient, but the water itself must be manually recharged.

In Zhang et al., U.S. Pat. No. 11,013,190 B2, the inventors are able to control the amount of water used for irrigation by taking into consideration the weather and existing soil moisture to control the delivery of water through automatic controls. Like Shih, U.S. Pat. No. 6,036,104, a combination of drip and spray irrigation systems are integrated to allow the user to choose the type of irrigation that is more suitable. The delivery of water is more limited as the valve openings are predetermined by soil moisture and humidity.

All of these patents attempt to create an efficient irrigation system that will reduce the need for the systems to be controlled and observed by a worker or user, while simultaneously lowering water loss through evapotranspiration, percolation, and runoff. However, none of these patents are able to extract and implement the usage of groundwater, which could also be cycled through water systems within water deprived areas to continue irrigation without the need for imported water supplies. The simpler one-pipe design and usage of nano-milled sand or silica powder as the material to initiate the groundwater extraction using capillary action is something that is unexplored. Rainwater irrigation, also a common practice, may be separated into two different functions after being filtered through a hollow fiber membrane filter. The clean water will be usable for the residence if desired, while the main function remains to deliver water to irrigation. The use of hollow fiber membrane capillaries will allow water to travel even slower at a steady rate to ensure the minimal plant need for water is met. This also limits the amount of water delivered at any given moment to prevent water percolation loss. Furthermore, the combination of two separate systems using rainwater and groundwater will save water and be more cost efficient for the user. During the more arid summer seasons, rainwater is less available and may be stored overtime and used less to save more water. Groundwater complements the previous system by constantly providing water to the soil above throughout the dry season.

### BRIEF SUMMARY OF THE INVENTION

The objective of the present invention must then be to provide a subsurface irrigation system that is able to be controlled automatically according to the moisture needs of the surrounding soil. A complementary relationship between the two systems will cooperate with each other to provide the necessary amount of water for the land area. To address the problems previously discussed, the following system descriptions provide an integrated solution with two systems.

The first system is described as a groundwater extraction irrigation system that pulls water up from the groundwater reservoirs very slowly over long periods of time. The system is described as following with:
(1) Several 4 in (10.16 cm) diameter PVC pipes that are a maximum 20 ft (6.10 m) in length;
(2) 0.2 in (0.508 cm) diameter absorption holes on the final 2 ft (0.61 m) of each pipe, as well as the top and bottom ends of the pipes;
(3) A 0.5 in (1.27 cm) diameter two-way transport pipe without any modification installed down the middle of the initial capillary irrigation pipe
(4) Utilizes nanomilled silica powder and/or sand with a diameter of 500 nm-6 μm;
(5) Uses a semipermeable bag to contain the nanomilled sand or silica powder;
(6) Uses a thick semipermeable layer to protect the two-way transport pipe;
(7) Layers of new compacted soil and topsoil layers on top to guide the water to the roots of the plants above, with 1 ft (32.8 cm) each of top soil and compacted soil.

Once the piping is installed, the water can be evenly distributed across the land area. This system can be stretched over large areas of land, depending on the local groundwater conditions and supply. On hills, the pipes must be staggered in height to accommodate for height differences. Furthermore, if the soil has too much water content due to weather conditions such as rain or snow or too much water was channeled, the water will percolate through the subsoil layers into the groundwater layer. The cycle begins anew with this new percolated water that recharges the groundwater layer and continuously delivers water into the subsurface capillary irrigation system. The use of nanomilled sand/silica powder makes capillary action more efficient as water can travel longer distances through the medium. This material is also environmentally friendly to obtain and use, which will not cause damage when handled properly. This also must be placed in a semipermeable bag that prevents the material from leaking into the environment or clogging the absorption holes.

The second system is described as a rainwater irrigation system that collects, filters, stores, and irrigates soil overtime according to the needs of the soil. The system is described as following with:
(1) The ability to transport water that is harvested in sloped collection trays on the roof of a user's residence;
(2) An untreated rainwater storage tank;
(3) A clean water storage tank;
(4) A hollow fiber membrane filter that removes suspended solids and other contaminants to generate potable water;
(5) The ability to perform filter self-cleaning by back flushing;
(6) Filtered water that may be used for both irrigation and consumption needs;
(7) A tap water supply pipe;
(8) Several water transport pipes;
(9) Several water pipe joints;
(10) A control panel that manages water volume used for irrigation by compiling data gathered from moisture detection devices;
(11) A water pump to channel water back into the filter for cleaning;
(12) Several pressure sensors to inform the control panel about water pressure differences, which suggest cleaning;
(13) Several moisture sensors;
(14) Lithium ion batter(ies);
(15) All systems powered by solar panels;
(16) An accessible interior for periodical cleaning and maintenance;
(17) Two water volume markers;
(18) A wastewater disposal system;
(19) 1 in (2.54 cm) diameter PVC pipes groundwater extraction pipes;
(20) 1 in (2.54 cm) diameter primary distribution pipe sections;
(21) 1/2 in (1.27 cm) diameter secondary distribution pipe sections;
(22) Several water collection nozzles;
(23) Several hollow fiber membrane capillaries to deliver water to soil.

By utilizing rainwater, users may filter and store such water for irrigation and consumption. This process relies on gravity, further reducing power consumption. The process begins when rainwater flows down the roof into rainwater collection trays, where the trays transport all of the dirty water into the unclean water storage tank. The water begins to slowly descend into the hollow fiber membrane filter, while contaminants such as leaves, pebbles, and sand settle to the bottom of the storage tank. This prevents large contaminants from entering into the filter system and reducing its effectiveness. The individual capillaries within the filter are able to take out smaller unwanted particles and bacteria to preventing microbial growth. A filter cleaning system is also integrated within the present invention. The installation of water pressure sensors on the input and output ends of the filter allow the system to analyze if the filter needs to be cleaned. If a pressure difference is calculated to be above a set value or threshold, then a water pump will be able to pump clean water back through to remove the clogged contaminants. This prolongs the filter's service life and reduces costs for maintenance. The treated water then follows through the rest of the cartridge where the treated water flows into a clean water tank.

Moisture sensors placed around the land will provide the system data about soil moisture requirements, which signal valves to open when the land is below the required moisture levels, and closes the valves when the soil is above or at required moisture levels. However, the user may also manually decide to open the valves using the control panel to irrigate despite adequate moisture sensor data levels. All of the sensors, connected by data and power cables, will be powered by a solar panel battery power system that can operate efficiently and store solar energy as needed during night or cloudy days. The use of clean energy reduces carbon emissions. If there is not enough power available in the batteries to adequately start the system, existing electrical systems within the user's residence will backup the batteries and continue the irrigation system without any interruption. Because of the low amount of energy required to power the system, the solar panel may be placed on a roof, making the system more discreet as the water tanks may be placed in a non-obvious manner that still contains a connection to the rainwater collection system.

After compiling and analyzing data received from the moisture detection devices, the system can determine the amount of water needed along with the areas in which water is needed. This system is crucial in minimizing water loss during irrigation, as a malfunction can cause an overspill of water. The system transports water through a series of primary distribution pipes that are connected to the water tank, while secondary distribution pipes branch out perpendicularly to the primary distribution pipes, covering large surface areas. The irrigation is carried out by hollow fiber membrane capillaries throughout the secondary distribution pipes. Because the water had been cleaned by the filter previously, there is little chance for a clog to occur. If a clog occurs, the detachable secondary distribution pipes may be removed and replaced. This piping must be placed in the topsoil layer, above the groundwater capillary irrigation pipes. A wet topsoil layer pulls more water from below, saturating both the topsoil and subsoil layers. Furthermore, because plant roots tend to grow towards saturated areas, fully saturated soil layers will create strong root systems that stabilize the surrounding soil and plant health.

If desired, the system may be programmed to deliver water to the user's residence and be used as potable water. Water may be automatically delivered inside of the residence by installing a transport pipe, or the user can open a manual valve installed outside of the clean water storage tank. This manual valve can also help the user test the water quality. In this aspect, areas with water shortages or droughts may collect rainwater, treat and clean it through filtration, and be able to use the water personally or for irrigation. The automation makes the system run efficiently based on soil moisture levels that greatly decrease the need for manual interaction with the device. This is highly beneficial to areas with a lack of water that may or may not be suffering from droughts. For areas in developing countries without a sustainable water system, the present invention may serve as both an automatic irrigation system as well as a drinking water provider. If the area is humid, the higher levels of rainfall will improve irrigation efficiency by directly saturating the top soil. If the water tanks do not contain any water, then existing tap water supplies may be connected to recharge the system to maintain irrigation. The percolated water from condensation will also sink through into the parent rock and bed rock, recharging groundwater supplies for the absorption capillary irrigation pipes. The water gathered within the clean water tank can also be used more efficiently for personal consumption, cooking, washing, etc.

These features, including others, will be further elaborated in the sections with references to the drawings described below.

### BRIEF DESCRIPTION OF THE SEVERAL VIEWS OF THE DRAWINGS

The present invention will be described below in more detail, with reference to the following accompanying drawings, in which:

FIG. 1 is an overview of the present invention's irrigation system, encompassing both above-ground and below-ground parts.

FIGS. 2A to 2C are sectional views of the parts used in the subsurface capillary irrigation system within the soil environment. FIG. 2A is a setup view of the piping system used, with the capillary irrigation pipes being situated below the rainwater irrigation system, with the soil layers cut away. FIG. 2B is a detailed sectional view of a singular capillary irrigation pipe, with the top end cut away to show the nanomilled sand/silica powder and the semipermeable bag that contains it. FIG. 2C is a sectional view of the top and bottom of the individual capillary irrigation pipes, with the bottom cut away to show the nanomilled sand/sillica powder and its semipermeable bag.

FIG. 3 is a detailed side view of the rainwater storage, filter, and pumping system with its respective parts. It also defines the individual functions for each valve in reference to FIG. 7.

FIGS. 4A to 4C are demonstrating the construction of the rainwater collection system with its slanted base to ensure water flow is constantly maintained. FIG. 4A is a top view of the rainwater collection system, with arrows showing water flow direction. FIG. 4B is a side view of the collection system. The system will be further described for structures with irregular roofs. FIG. 4C is a detailed depiction of the individual assembled parts of the rainwater collection trays.

FIG. 5 is a detailed sectional embodiment of the internal structure of the hollow fiber membrane filter and its respective piping connections, with arrows depicting water flow directions.

FIGS. 6A to 6C consist of an cut-away top view and detailed views of the parts used in the rainwater irrigation system. FIG. 6A is a schematic top-view presentation of the rainwater irrigation system within the soil environment, with the soil layers cut away to give more focus to the piping. FIG. 6B is an exploded perspective of the individual assembled parts in the irrigation piping. FIG. 6C is a side-view of the parts as shown in FIG. 6B, showing the connection of the capillaries to the distribution pipes.

FIG. 7 is a flow diagram representing the rainwater transport system's methods of distributing water throughout the day, as programmed by a control panel.

FIG. 8 is an embodiment of the power and data connections and how each part interacts and functions with each other, with the programmed explanations for reference in FIG. 7.

### DETAILED DESCRIPTION OF THE INVENTION

In the following description of the present invention, specific embodiments of the invention are referenced and described. However, parts and features of the embodiments may be interchanged, unless explicitly stated as otherwise. Specific details are described within the description below to allow for a more thorough understanding of the functions of the system. Each descriptive detail is described to maintain focus on the present invention and its various functions.

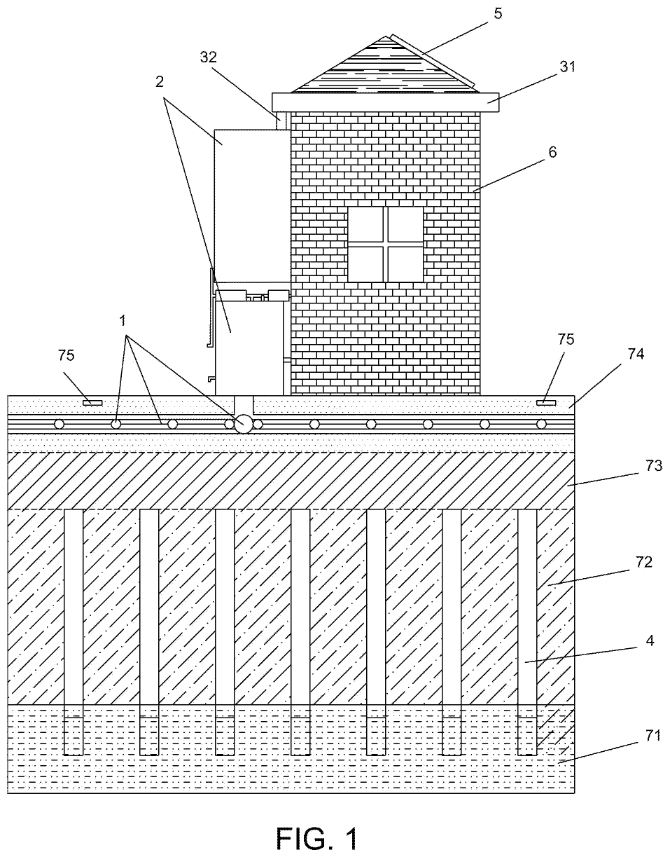

In FIG. 1, the present invention is divided into two separate systems, with the first system as the subsurface capillary irrigation pipes 4, and the second system as the rainwater irrigation system. This general overview of the system applies to all landforms, as the subsurface capillary irrigation pipes 4 may be offset to compensate for hilly and/or dry terrain. The soil layering is divided into four separate sections: The groundwater retaining layer 71; The pipes are placed within 72, a layer of subsoil; At the top of each pipe 73, a layer of compacted soil is used to transport the moisture from the pipes up to 74, the topsoil.

Also, moisture detection devices 75 are placed throughout an area of land, connected to an indoors control panel, to ensure that water is being transported whenever needed to its various destinations.

In the top soil layer 74, the rainwater irrigation distribution pipes 1 are supplied by the water storage system 2, which is situated right outside of a residence/building 6. The placement of such a storage system is not specifically limited to residential installations, and may be applied to any similar building that maintains the same processes as described without the cessation of any particular function. Certain parts in the water storage system 2, including moisture detection devices 75, are all powered by a solar power system 5. It is also important to note that the embodiment of the rainwater irrigation distribution pipes 1 remain as depicted, and should not be placed in lower water layers. This will cause the compacted soil layer 73 to become oversaturated and cause water to percolate from gravity instead of succumbing to capillary forces. The soil layer offset between the two systems ensures that the two systems will not counter each other and cause undesirable effects.

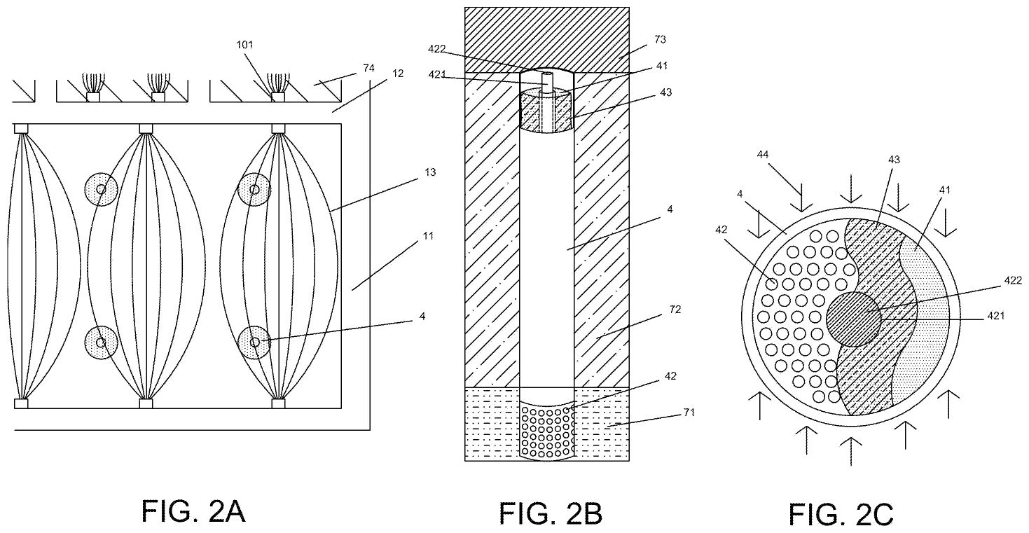

This two-part irrigation system prevents evapotranspiration by delivering water to the soil and plants as needed when the subsurface irrigation pipes are unable to supply enough water to meet surface demands. Due to the same reasons listed above, water is unable to percolate and sink below to groundwater layer 71 and subsoil layer 72 if the water requirement is met. In different weather conditions, such as rainy or snowy days:
(1) Rainwater collection trays 31, delivery pipe 32, and water storage system 2 will be able to capture rain and snow, and store the filtered meltwater;
(2) The topsoil 74 will absorb much of the condensation, reducing water needs;
(3) If heavy rainfall or floods occur, the water will naturally percolate into lower soil layers and recharge the groundwater by the two-way transport pipe 421, which is explained further in FIG. 2B;
(4) If desired, this filtered water may be delivered into the residence and be used as potable water.

In FIGS. 2A to 2C, the subsurface capillary irrigation system 4 is focused on. Specifically represented in FIG. 2A, situated within the compacted soil layer 73, the capillary irrigation pipes are installed underneath the rainwater irrigation pipes 11, 12, and 13, and water collection tray 101. Likewise, the installation distance intervals for the subsurface capillary irrigation system 4 pipes will also depend on groundwater levels, weather conditions, and humidity levels. Such an irrigation system is not regulated or controlled by any device, because of the slow rise of water from the groundwater layers 71. Thus, closer placement of the subsurface capillary irrigation system 4 pipes is preferred.

Specifically represented in FIG. 2B, a singular subsurface capillary irrigation system 4 pipe is shown and cross-sectioned to examine the interior of the pipe. Situated in the subsoil layer 72 and joined by the compacted soil layer 73 above, the absorption holes 42, situated in the final section of the pipe, will draw water from the groundwater layer 71 as nanomilled sand or silica powder 41 transports the water over longer distances by capillary action. This nanomilled sand or silica powder 41 is contained within a semipermeable bag 43 to prevent any the sand from leaking into the environment. The design of the bag also has to be specially made to accommodate for a hole in the middle of the semipermeable bag 43. A two-way transport pipe 421 is installed into the middle of the capillary irrigation pipe, which is connected to the bottom end of the pipe. This pipe is covered on both sides by a thick geotextile layer 422 to prevent any dirt from clogging the pipe, so that any water that percolates will easily travel down to the groundwater layer 71. Inversely, if any water begins to travel through the airpocket in the two-way transport pipe 421, the moisture can also travel upwards into the soil layers above. This system creates a more efficient water recharging and irrigation setup.

Nanomilled sand is produced via specialized equipment that is able to grind down small particles into micro- or nanoparticles, greatly decreasing the distances between individual particles, which in the present invention, are sand or silica particles. This material is chosen because of its availability and hydrophilic properties. Nanomilling has been very limited with its range of uses, with pharmaceutical companies dominating the market for this equipment. The present invention creates a possibility of broadening its range of uses with irrigation.

The length of the piping required can be calculated using the capillary rise formula:

h=2T cos θ/rρg (1)

where h is the capillary rise height, T is the surface tension of the liquid measured by N/m, θ is the degree at which the liquid and capillary walls meet, r is the radius of the pipe in m, ρ is the density of the liquid in kg/m³, and g is the acceleration of the liquid due to gravity, which is 9.8 m/s². In this case, since the subsurface capillary irrigation pipes 4 contain filling, the radius of the largest particle is used, which is 30 μm. If the surface tension of water is 72.8×10⁻⁷ N/m, its angle at which it meets the subsurface capillary irrigation pipes 4 is 0°, its density is 1 kg/m³, the acceleration due to gravity is 9.8 m/s², and the radius is 3 μm or 3.0×10⁻⁶ m, then the capillary rise will be calculated.

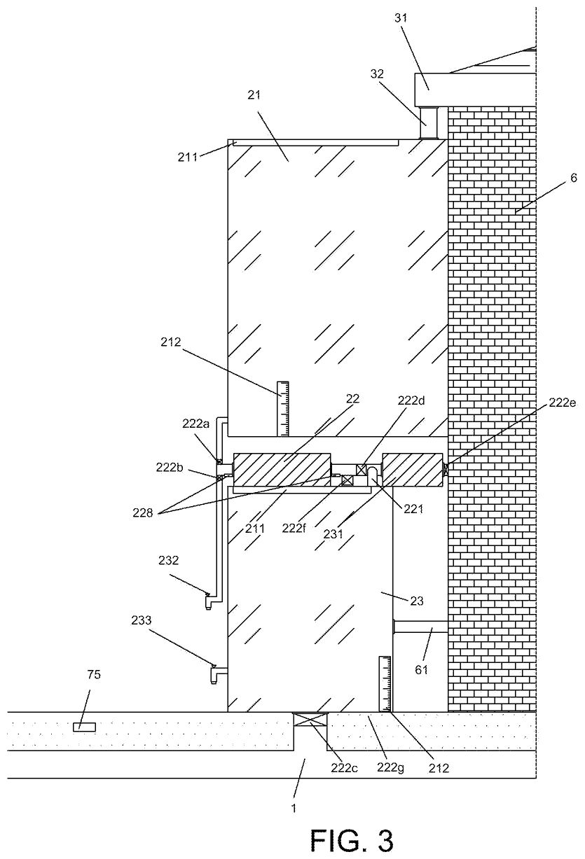

Specifically represented in FIG. 2C, a side view embodiment of the ends of the subsurface capillary irrigation pipes 4 is shown, with cutout portions that show the internal contents of the pipe, with nanomilled sand/silica powder 41, absorption holes 42, and the semipermeable bag 43. Groundwater flow, indicated by arrows 44, enter the pipe and uses capillary action to travel upwards and be delivered to the soil and plant roots above. The absorption holes 42, depicted in both FIGS. 3B and 3C, are 0.1 in (0.25 cm) in diameter spaced the same distance apart, are installed on both the top and bottom of the subsurface capillary irrigation pipes 4.

The installation of the parts represented in FIG. 2A to 2C require a pilot hole to be driven down into groundwater layers, which allows the subsurface capillary irrigation pipes 4 to be installed along with its drilled absorption holes 42 and two-way transport pipe 421. The top layer of the pipe will not be installed until the end. Then, a geotextile semipermeable bag 43 that has already been filled with nanomilled sand/silica powder 41 is lowered into the pipe. Any dirt that is present in the piping may be left alone. Now, the top layer of the pipe is added to fit snugly to the contour of the semipermable bag, so there is a minimal gap between the nanomilled sand/silica powder 41 and the compacted soil layer 73 above. This process is repeated for every pipe placed. Afterwards, a 3 feet (91.44 cm) thick layer of compacted soil is used to cover up the pipes, while the topsoil is not added to allow the user to install the rainwater irrigation distribution pipes 1.

In FIG. 3, a detailed overview of the rainwater irrigation system is shown. For the purposes of showing the individual parts of the water storage system 2, the rainwater irrigation distribution pipes 1, the rainwater collection trays 31 and delivery pipe 32, and the moisture detection device 75 will be simplified. The untreated water storage tank 21 receives all of the rainwater and stores it, where it supplies water through the transport pipes 221, hollow fiber membrane filter 22, and valves 222 into the clean water storage tank 23. The transport pipe 221 is not directly under the clean water storage tank 23 because sediments and contaminants will sit at the bottom. Instead, the transport pipe 221 will be installed along the side, 2 in (5.08 cm) above the base. The different tanks may also be periodically maintained and cleaned through the access doors 211. During a periodic maintenance check, the sediment may be cleaned out directly. Also, the user may utilize the water volume marker/automatic water volume detection device 212 to check the water level in both storage tanks manually, while the system relies on an the internal water volume detection device 212, to check water levels for its individual functions. This system separates both clean and unclean water to prevent contaminants from entering the irrigation system and causing a clog.

The filtration system is also able to generate potable water, which then the clean water storage tank 23 is able to deliver to the residence/building 6, if desired. Inversely, if the clean water storage tank is empty, a tap water supply valve 61 is installed to fill the tank if needed. In the case of regions with water shortages and/or droughts, this system will collect rainwater and safely filter and store it, which can then be used for various purposes. The hollow fiber membrane filter 22 can be cleaned by the water pump 231, which takes water from the clean water storage tank 23 and push water back through the filter, where the wastewater exits through a manual disposal valve 232. The delivery valve 222 may also be connected to existing wastewater disposal systems installed in the area. Also, a second manual water valve 233 is installed to the clean water tank so that above-ground irrigation is still possible when connected to a hose. Furthermore, the water can be used via the manual valve to test for pH, total dissolved solids (TDS), turbidity, etc. The valve system 222 is all controlled by a control panel indoors, which control individual valves and when they are opened or closed. This system is assembled by PVC piping connected to stainless steel or polyethylene storage containers, preventing rust issues and ensuring durability.

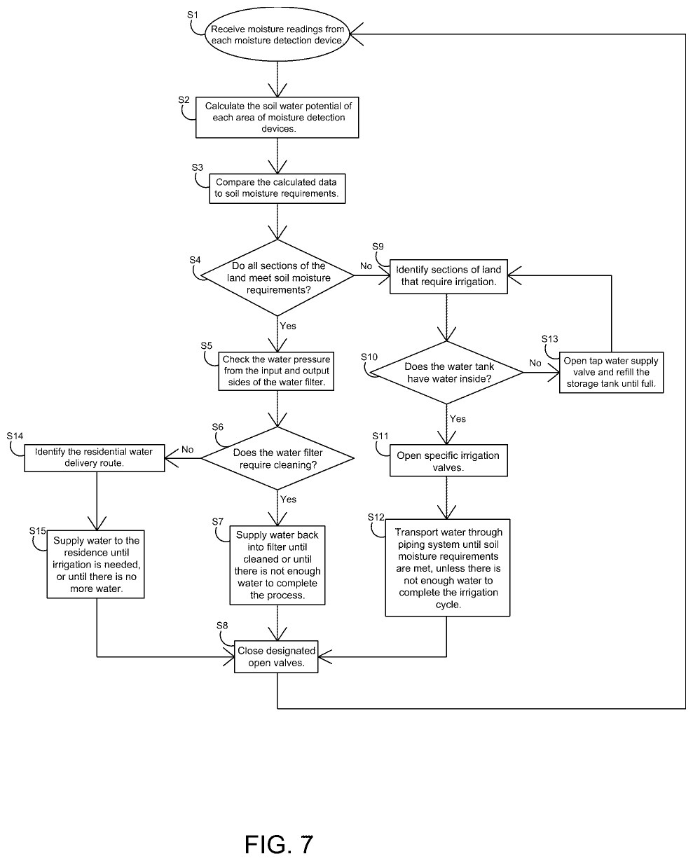

The following list defines the valve system 222 by its constituent valves and their roles in the rainwater irrigation system:
(1) Valve 222a is the untreated water flow valve that opens to allow water to flow into the hollow fiber membrane filter 22.
(2) Valve 222b is the wastewater disposal valve that opens to allow wastewater to exit the system after the hollow fiber membrane filter 22 is cleaned.
(3) Valve 222c is the irrigation valve that opens whenever moisture detection devices 75 detect a sufficient lack of water in the soil.
(4) Valve 222d is the water pump valve that opens to allow clean water to be pumped back into the hollow fiber membrane filter 22 for cleaning.
(5) Valve 222e is the residential water delivery valve that opens to allow clean water to be pumped into the residence/building 6.
(6) Valve 222f is the clean water entry valve that opens to allow clean water to enter the clean water storage tank 23.
(7) Valve 222g is the tap water supply valve that opens to allow clean water to enter the clean water storage tank whenever the tank is empty.
In reference to the overview listed above, the following describes each valve command, also with reference to the steps listed in FIG. 7:
(1) When water enters the rainwater collection system 31, the valve opened by default is the untreated water flow valve 222a, whilst other valves are performing automatic functions as outlined in FIG. 7. Valve 222f also opens to allow water to enter the clean water storage tank 23. This valve opening does not affect any other valve, nor will it be closed, until the system requires the hollow fiber membrane filter 22 to be cleaned. It continuously supplies water through the filter into the clean water storage tank 23 to keep as much water present as possible in the tank.
(2) When water is being redelivered back into the hollow fiber membrane filter 22, the clean water storage tank 23 pumps water through the water pump 231. Valves 222b and 222d are opened, whilst all other valves are closed so that the wastewater that is generated from the cleaning can be safely disposed in the manual disposal valve 232. This is referenced in step S7 in FIG. 7.
(3) When water is being delivered to the rainwater irrigation pipes 1, the clean water storage tank 23 supplies water through valves 222a and 222c. All other valves are closed so that the water supply can be dedicated to irrigation purposes. This is referenced in step S12 in FIG. 7.
(4) When water is received from the tap water supply pipe 61 into the clean water storage tank 23, valves 222a and 222g are opened. All other valves are closed until the tank is full to ensure that the system can resume its functionality properly. This is referenced in step S13 in FIG. 7.
(5) When water is being delivered to the residence/building 6, the water pump 231 pumps water from the clean water storage tank 23. Valves 222a and 222e are opened, whilst all other valves are closed so that the water supply can be dedicated for the user. This is referenced in step S15 in FIG. 7.

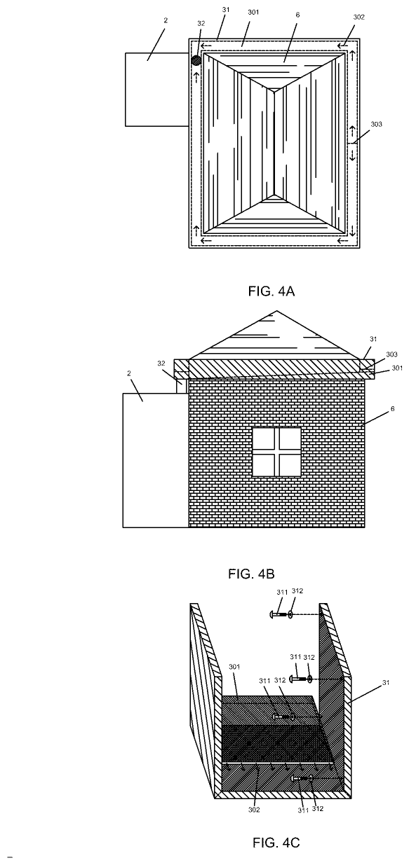

In FIGS. 4A to 4C, a top view of the rainwater collection system is presented without the solar power system and the details of the rainwater storage system 2 drawn in, to give more focus to the system design. Specifically represented in FIG. 4A, a top view of the rainwater collection trays 31 shows how rainwater will travel down the roof of the residence/building 6 and follow a travel path as shown by the arrows 302. Slanted tray bases 301, starting from its slanted tray peak 303, allow water to travel down the delivery pipe 32 into the rainwater storage tank 2. This embodiment is of a simple four-walled building, which may prove to be more difficult to install on irregularly shaped buildings that may have have many walls and longer distances to cover. To accommodate for the extra distance, rainwater collection trays 31 may have to be installed beneath the roof line. Another solution would be to install a second rainwater irrigation system and to connect the systems via piping and control panels. Specifically represented in FIG. 4B is a side view of the rainwater collection system 31, with dotted lines representing the slanted tray bases 301 and the slanted tray peak 303.

Specifically represented in FIG. 4C, a section of the rainwater collection tray 31 is shown with its individual parts. The walls of the tray base are welded if made of stainless steel, otherwise the tray may be made of polyethylene for more sturdiness. As previously mentioned, the base of the rainwater collection trays 31 have a slanted base 301 to guide water along into the storage system. The slant of the tray base is minimal to allow water to travel more distance with a calmer flow into the storage system. The direction of water flows along the base, represented by arrows 302. This slanted base 301 is installed on top of the existing base, and may be removed and replaced for damage or cleaning purposes. The rainwater collection trays 31 are installed onto the roof by installing screws 311 and washers 312 into pilot holes. This embodiment does not accurate demonstrate the distances in which the screws have to be installed from each other, and are spaced much further apart than as depicted.

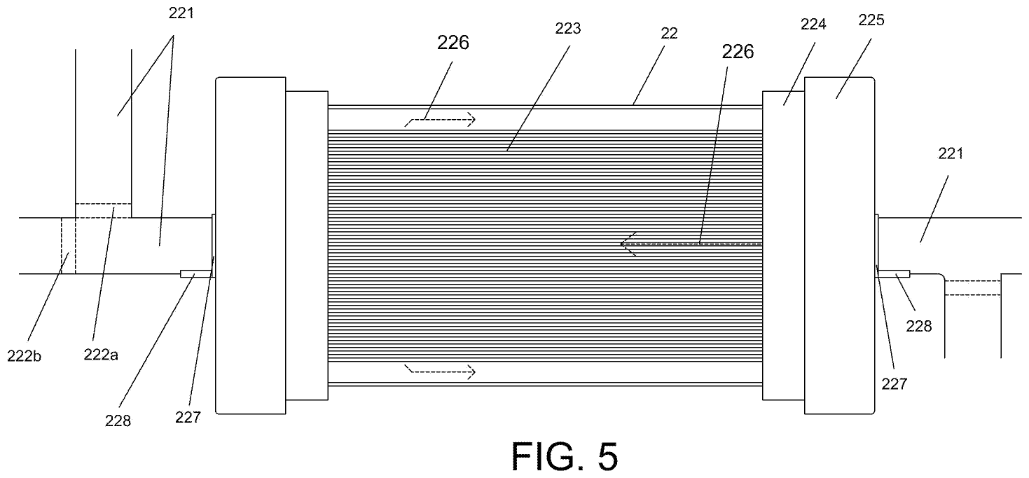

In FIG. 5, a close up view of the interior of the hollow fiber membrane filter 22 is shown, along with the connected piping and valve systems. As water comes down from the unclean water tank and travels through the transport pipes 221, it is received by the filter, where the hollow fiber membrane capillaries 223 are able to capture and filter out the waste material in the water, where the empty space surrounding the hollow fiber membrane capillaries 223 receive and transport the clean water, as shown by internal arrows 226. The filter is also protected by a hard internal cartridge 224, as well as the hard plastic housing 225 that connects the piping to the filter itself. When the water exits the filter into yet another transport pipe 221, it will head towards the clean water storage tank 23. As described in FIG. 5, water is pumped up into the water filter 22 through the transport pipe 21, into the capillaries contained within. This process continues for three seconds after the cleaning process is over to ensure that all contaminants are removed. Because the hollow fiber membrane capillaries 223 are open-ended on the input side of the filter, the reverse water flow will push the contaminants back into the transport pipe, where valves 222 open and close accordingly to permit the wastewater to pass through. This cleaning system is engaged when the water pressure sensors 228 detect a large difference between the input and output water pressures, which indicate that a blockage has occurred and cleaning is needed. This system prolongs the service life of the water filter 22 with minimal water loss. If needed, the joints of the piping 227 can be disconnected, and the water filter 22 may be replaced.

The hollow fiber membrane capillaries 223 are identical to those that are used for irrigation, both serving the same purpose as a semi-permeable membrane. However, the hollow fiber membrane capillaries 223 within the water filter 22 have extra layers and coatings to prevent membrane fouling, which means the slow degradation of the filtered water overtime due to chemical pollutants. Polysulfone hollow fiber membrane capillaries are coated in a combination of chemicals such as N—TiO₂—NH₂ (NTN) and 3-(3,4-dihydroxyphenyl)lalanine (LDOPA). If desired, an activated carbon filter may be attached as a part of the filter system as a pre-treatment in the unclean water tank to help draw out more contaminants.

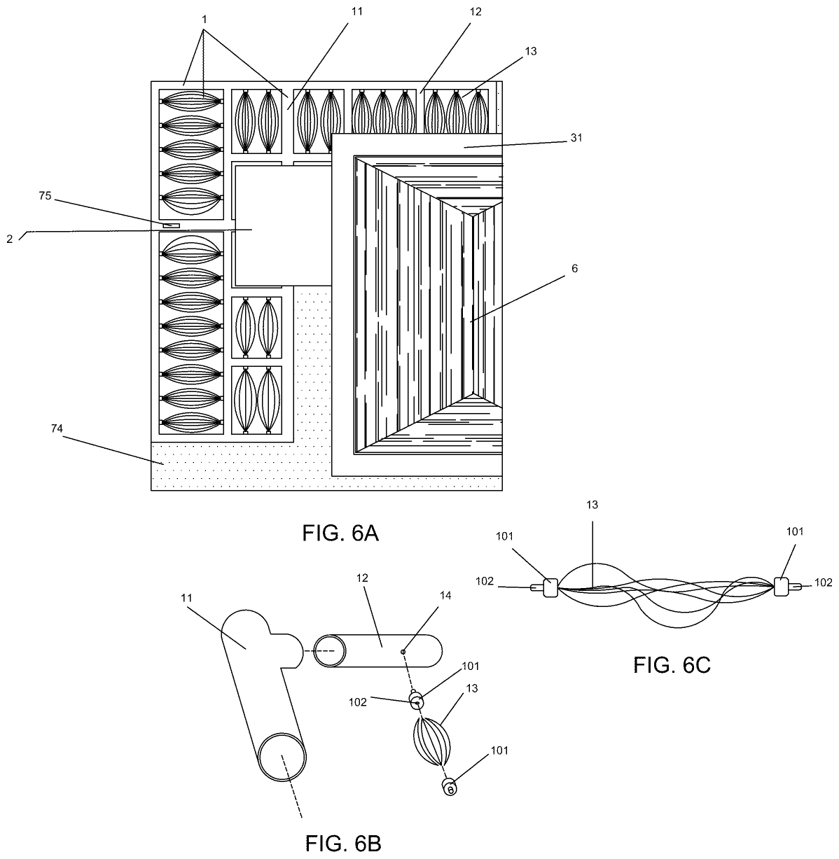

In FIGS. 6A to 6C, the rainwater irrigation system is focused on, containing an overview as well as detailed depictions of the described setup. Specifically represented in FIG. 6A, a view of the entire rainwater irrigation system is depicted, as rainwater collection trays 31, mounted on a residence/building 6, deliver water into the water storage system 2, where the rainwater irrigation distribution pipes 1 begin to distribute the water. The piping is divided into the primary distribution pipes 11, secondary distribution pipes 12, and hollow fiber membrane capillaries 13 that serve as the conduit for water to be absorbed into the topsoil 74. The capillaries function as a semipermeable membrane that does not allow soil particles to enter the water stream, while allowing the water to leave the membrane. The embodiment of the piping system allows extra water to flow back through other secondary distribution pipes 12. The amount of water allowed through the pipes are dependent on the data that the moisture detection devices 75 show.

The primary distribution pipes 11 branch out from the origin, and are connected by secondary distribution pipes 12 and hollow fiber membrane capillaries 13 that are installed on a predetermined interval based on the location's humidity and weather conditions. The installation distance intervals for the moisture detection devices 75 also depend on the factors listed previously. The soil constantly receives water until the moisture requirements are met, and the valves are closed, powered by the solar power system 5.

Installation of the depicted system can be performed easily as sections of rainwater irrigation distribution pipes 1, connected by hollow fiber membrane capillaries 13, are lowered into the soil, which has already been dug out previously for the subsurface capillary irrigation pipes 4. Furthermore, because the present invention utilizes semipermeable capillaries to transport water, very little contaminants are able to enter the irrigation system and cause a clog. These piping and storage system may also be duplicated onto other buildings, where the piping may be connected and further increase the amount of water that is able to be stored and used.

Specifically represented in FIG. 6B, a diagram of how the different parts of the rainwater irrigation system are assembled is shown. The primary distribution pipe 11 is fitted to the secondary distribution pipe 12, where some of the transported water enters a water collection tray 101. It is fitted partially into the pipe, where entry holes 102 allow water to flow in and out of the water collection tray 101. This allows sufficient water to be rerouted into the hollow fiber membrane capillaries 13, while the rest of the water is able to leave the system through exit holes 102 on the opposite end. An important aspect of this design is the flexibility of the hollow fiber membrane capillaries 13, which can be flexed into different curves to cover large areas of land without the need for a lot of piping. Underground organisms and animals will not choose to damage them, and the system allows the user to easily traverse around the capillaries. Instead of digging around large areas of hard PVC piping, the hollow fiber membrane capillaries can be moved aside.

Specifically represented in FIG. 6C, an embodiment of the side of the tray and capillary system is shown to demonstrate the flexibility of the hollow fiber membrane capillaries 13. Water enters and exits the entry/exit holes 102 on both ends of the water collection trays 101, which are installed into water holes 14. The hollow fiber membrane capillaries 13 can be manipulated and shaped to deliver water at different depths for a more thorough and effective irrigation process. Many hollow fiber membrane capillaries 13 may also be connected to the trays to increase water volume, since one is not sufficient for practical irrigation purposes.

In FIG. 7, a flow diagram of the processing system in a control panel/system/program 53 is shown, connecting different functions with each other based on real time needs in four different areas. The diagram is ordered in importance, as the primary function of the present invention is for irrigation and to maintain the moisture levels of the land in real time. Then, the system considers different factors to determine its next action, whether it be to deliver water to the residence/building 6 or to clean the filter.

FIG. 7 is comprised of method S from steps S1 to S15.

Step S1 receives data readings from different sections of soil and compiles them for step S2 to process the data.

Step S2 analyzes data it receives from moisture detection devices 75 placed in different areas of the soil and calculates an average for different sections of the soil. Moisture detection devices are installed in the first 5 inches of topsoil for the most accurate data.

Step S3 compares the calculated average moisture of different sections of the soil to the predetermined moisture requirements. This is calculated by the amount of water best needed to maintain plant health based on soil water potential. This shows exactly how much water the plants need, minimizing water loss.

Step S4 judges the difference in calculations and determines if the different soil sections meet the requirements. If they do, proceed to step S5. If not, proceed to step S10.

Step S5 checks the difference in water pressure in both the input and output water pressure sensors 228 of the hollow fiber membrane filter to evaluate whether or not a clog exists. When the output end detects a lower water pressure than the input end, then it can be assumed that a clog is slowing down the filtration process and lowering water pressure. The system then proceeds to step S6.

Step S6 compares the differences in water pressure, if there exists any difference, and decides whether or not the system needs to clean the hollow fiber membrane filter. The system does not activate a cleaning sequence whenever a difference is detected, which is when the system proceeds to step S15. If a large difference is detected, proceed to step S7.

Step S7 is a cleaning sequence that begins if and only if irrigation is not needed in any part of the soil. This step is less common than step S15, but is more essential to the entire system as a whole. Water will be supplied into the system until three seconds after the hollow fiber membrane filter 22 is cleaned, unless there is not enough water to complete the cleaning sequence. If irrigation is needed, then the irrigation sequence will override the current one.

Step S8 closes certain valves in the valve system 222, and is always the final function that is automatically performed. The system will then proceed to step S1, given that step S9 is not activated.

Step S9 is a response to step S4, and begins to identify the specific areas that require irrigation. The primary distribution pipes should branch out in different directions that maximizes soil coverage without the need for the user to install extra distribution pipes. However, the preferred angle of installation is 90 degrees, since it virtually divides the land into four quadrants, which can make the irrigation process easier as one specific quadrant can be identified.

Step S10 checks the clean water tank 23 to see if there is any water remaining. If there is no detectable water, proceed to step S13. If there is water, proceed to step S11. This positive response will be initiated independent of the actual amount of water contained within, even there is very little water remaining. The control panel 53 is programmed to place this route as its primary route, whilst other functions are not as important to the irrigation system, functionality wise.

Step S11 opens the designated irrigation valves that are specific to the quadrant that it is delivering water to. If there are multiple open pathways, the water will naturally divide evenly without priority to any path.

Step S12 transports water and irrigates the soil until the moisture detection devices 75 return a good reading, or until the system is forcefully stopped as a result of a lack of water in the clean water storage tank 23. When the system eventually stops, proceed to step S8.

Step S13 is a response to step S10, which opens the tap water supply valve 61 to receive water when the clean water storage tank 23 needs to be recharged with water to resume its activities. After the tank is fully recharged, it cycles back to step S9 so that the irrigation cycle may resume as normal.

Step S14 is a response to step S6 that begins if and only if irrigation is not needed in any part of the soil, and that the hollow fiber membrane filter 22 does not require cleaning. This function is performed under the assumption that there exists a residential water delivery pipe, which is preferable. Otherwise, this sequence must be terminated manually by the user so the function may be redirected to step S1, the path of which is not shown.

Step S15 follows step S14 by supplying water to the residence/building 6 until steps S1 to S4 detects that irrigation is needed again. This water is potable and may be used for many purposes, such as washing, cooking, hygiene, drinking, etc. This is a highly efficient way of balancing water usage in arid areas, as the control panel 53 may be programmed to the user's wishes. After the supply is stopped, the programs proceeds to step S8, where the entire system cycles back to step S1.

Throughout the cycle, the system is also awaiting for any manual inputs, which may initiate and terminate any command, overriding any other running command. This allows the user to have full control over the functions of the rainwater irrigation system so that the water may be more efficiently distributed instead of being fully dedicated to irrigation.

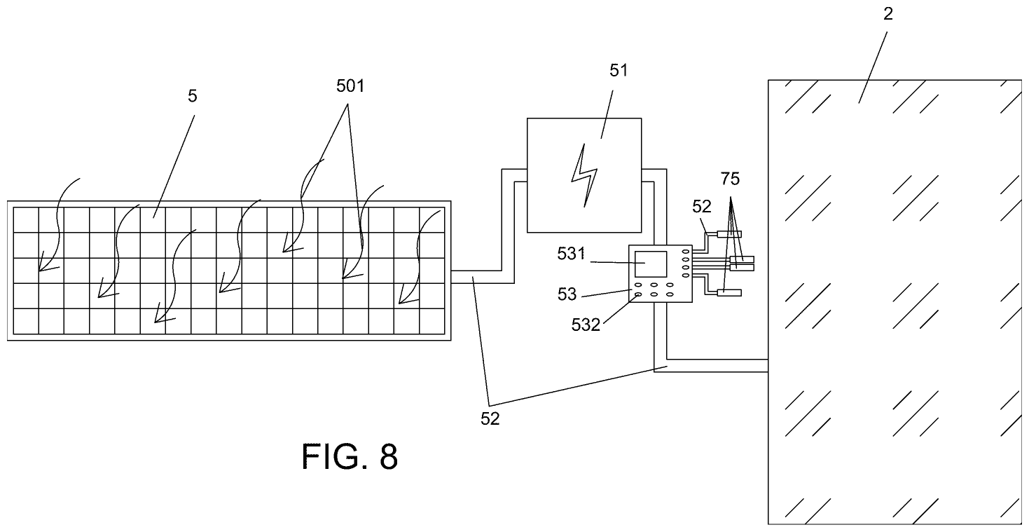

In FIG. 8, an embodiment of the structure of the power and data transfer systems are shown. The wiring of the system, connected by electric and/or data wires 52, allow the individual parts in the system to communicate with each other, and allow the program described in FIG. 7 to function. When the solar panels 5 receive sunlight, depicted by arrows 501, the power is transferred by electric wires to a lithium ion battery 51, where the power can be stored and used over long periods of time. Then, the power is transferred to the control panel 53, where the electricity powers all of the valves in the water storage system 2, power and receive data from the moisture detection devices 75, and power itself to allow itself to check its functions in FIG. 7 every 5 minutes. The control panel 53 consists of a display screen for the user and buttons 532 to choose options and power on/off the system if needed. Solar power allows the system to be powered efficiently without increasing existing electricity storage, and the lithium ion battery 51 keeps the power without waste. If needed, an extra electric wire 52 may be connected to the battery from the electrical grid to maintain power. This system maintains carbon neutrality throughout all of its activities, as it does not need to rely on any source of processed water and electricity to carry out any activity, and only requires supplies for an occasional recharge or maintenance.

### SEQUENCE LISTING

Not Applicable

What is claimed is:

1. A subsurface groundwater irrigation system of individual modified PVC subsurface capillary irrigation pipes 4 placed in a grid fashion, wherein the improvement comprises:
4 in (10.16 cm) diameter subsurface capillary irrigation pipes 4 which are a maximum 20 ft (6.10 m) in length
0.2 in (0.508 cm) diameter absorption holes 42 which are located on the last 2 ft (0.61 m) of the subsurface capillary irrigation pipes 4, as well as the top and bottom ends of the subsurface capillary irrigation pipes 4;
A 0.5 in (1.27 cm) diameter two-way transport pipe 421 installed in the middle of a subsurface capillary irrigation pipe while being connected to its bottom end;
A semipermeable bag 43, constructed of geotextiles that specially accommodates for a hole in the middle of the bag;
Two thick semipermeable layers 422, constructed of geotextiles, that closes up the top and bottom ends of the two-way transport pipe 421;
The semipermeable bag is filled with nanomilled sand or silica powder 41 with a diameter between 500 nm and 6 μm, where the geotextiles serve as a barrier that prevents the nanomilled sand or silica powder from exiting the system;
Wherein the system of subsurface capillary irrigation pipes 4 are buried underneath top soil layers 74 and plant root systems;
Wherein the system of subsurface capillary irrigation pipes 4 are independent in function from all other systems;
Wherein the system of subsurface capillary irrigation pipes 4 draw water from a groundwater layer 71;
Wherein the system of two-way transport pipes 421 can recharge and draw water from a groundwater layer 71 so that percolated water will not be lost or trapped;
Wherein the design of the present system will use excess rainwater or condensation otherwise to recharge the groundwater layer 71;
Where in the system of subsurface capillary irrigation pipes 4 are installed in drilled holes within the subsoil layer 72, underneath designated soil layers;

2. A subsurface groundwater irrigation system as in claim 1, wherein a soil layer modification system is created to improve soil moisture retention, absorption, and transport, further comprises:
A topsoil layer 74 that is 1 ft (32.8 cm) thick with little to no rock sediment;
A compacted soil layer 73 that is 1 ft (32.8 cm) thick with little to no rock sediment, as well as air pockets;
A subsoil layer 72 and groundwater layer 71 that will not be modified to protect soil ecosystems and prevent possible environmental damage;

3. A rainwater irrigation system wherein the rooftop rainwater collection system comprises:
Multiple rainwater collection trays 31;
Multiple slanted bases 301 installed onto the bottom of the rainwater collection trays 31 without the use of tools;
A slanted tray peak 303 to indicate the beginning of the slanted bases 301 for installation references;
Screws 311 and washers 312 that secure the rainwater collection system to the roofing;
A delivery pipe 32 that connects the rainwater collection trays 31 to the water storage system 2;
Wherein all rainwater collection trays 31, slanted bases 301, a slanted tray peak, and a delivery pipe are constructed out of PVC, polyethylene, or stainless steel;
Wherein all slanted bases 301 may be easily removed and cleaned as needed;

4. A rainwater irrigation system as in claim 3, where in the water storage system 2 further comprises:
An untreated water storage tank 21;
A clean water storage tank 23;
Two access doors 211, with one installed on each water storage tank;
Two glass water volume markers 212, with one installed on each water storage tank;
A manual water valve 233 that allows the user to obtain samples to test for pH, TDS, turbidity, etc.;
A tap water delivery valve 61 that recharges the clean water tank 23 when needed;
Wherein both water storage tanks 2 are connected by transport pipes 221 and water valves 222 that are connected to the central water filter 22 and water pump 231;
Wherein sediment and contaminants may settle in the bottom of the untreated water storage tank 21;
Wherein the untreated storage tank 21 is placed above the clean water storage tank 23, separated by the water filter 22 system in between;
Wherein all valves and the water pump 231 are powered by a solar panels 5;

5. A rainwater irrigation system as in claim 3, wherein the water filtration and cleaning system further comprises:
Multiple internal hollow fiber membrane capillaries 223, protected by an inner cartridge 224 and an outer housing 225;
Several external transport pipes 221 that connect the untreated water storage tank 21, the water filter 22, and the clean water storage tank 23;
An input and output water pressure sensor 228 installed on both ends of the water filter 22;
Piping joints 227 that secure all connections made by the transport pipes 221;
A manual disposal valve 232 that removes all wastewater that is created by washing the water filter 22;
A cleaning function in which clean water is pumped back by the water pump 231 through the water filter 22 to remove contaminants;
Wherein the cleaning function is defined by a negative difference between the water pressure of the output and input water pressure sensors 228;
Wherein the cleaning function continues for three seconds after the water filter 22 is clean, which is defined by an equal or positive difference between the water pressure of the output and input water pressure sensors 228;
Wherein all transport pipes 221 control water flow via water valves 222 by a programmed system;
Wherein the water filter is made of LDOPA and NTN treated polysulfone hollow fiber membrane capillaries to prevent the slow deterioration of water quality by chemicals;
Wherein the water filter is able to produce potable water that is safe for consumption and other uses other than irrigation;

6. A rainwater irrigation system as in claim 3 that receives water from the water storage system 2 after all of its processes to deliver water to the topsoil 74, further comprising of the following parts:
Multiple 1 in (2.54 cm) diameter primary distribution pipes 11 constructed of PVC;
Multiple 1/2 in (1.27 cm) diameter secondary distribution pipes 12 constructed of PVC;
Multiple hollow fiber membrane capillaries 13 connected to secondary distribution pipes 12;
Wherein all distribution pipes 1 originate from the water storage system 2;
Wherein all distribution pipes 1 may be connected to several rainwater irrigation systems;
Wherein irrigation is performed solely by hollow fiber membrane capillaries 13, which are flexible and covers large areas of land;
Wherein installation of the system is restricted to topsoil layer 74;
Wherein the water volume required to irrigate the topsoil layer 74 is based on the calculations of the control panel 53;
The assembly of the piping further comprises:
(1) Multiple water collection trays 101 with multiple entry/exit holes 102 installed within a water hole 14;
(2) Multiple hollow fiber membrane capillaries stemming on each end from a water collection tray 101;
(3) Wherein the hollow fiber membrane capillaries 13 are able to be moved and shaped to any extent, and their lengths are only constrained by a maximum;

7. A rainwater irrigation system as in claim 3, wherein a central control system and data acquisition system that is automatically programmed and controlled by a user further comprises:
A solar power system 5 placed on the roof that generates power for the rainwater irrigation system;
A lithium ion battery 51;
Multiple electric and/or data wires 52;
A control panel 53 that contains internal commands that initiate and terminate all processes in the water storage system 2;
A control panel 53 that is able to receive and process data as needed from moisture detection devices 75;
Wherein the control panel is further comprised of an interactive display screen 531 and several manual buttons 532;
Wherein the control panel is programmed with moisture calculation algorithms based on soil water potential, water level detections that are based on water pressure sensor 228 data, and a water filter cleaning function that is also based on water pressure sensor 228 data;
Multiple moisture detection devices 75 that are placed in different intervals across an area of land;
Wherein the moisture detection devices 75 transmit information about soil moisture to the control panel 53

8. A valve control system based on moisture level data, water availability data, and water pressure data, wherein the improvement comprises:
S1: receives data readings from different sections of soil and compiles them for step
S2 to process the data;
S2: analyzes data it receives from moisture detection devices 75 placed in different areas of the soil, and calculates an average for different sections of the soil. Moisture detection devices are installed in the first 5 inches of topsoil for the most accurate data;
S3: compares the calculated average moisture of different sections of the soil to the predetermined moisture requirements. This is calculated by the amount of water best needed to maintain plant health based on soil water potential. This shows exactly how much water the plants need, minimizing water loss;
S4: judges the difference in calculations and determines if the different soil sections meet the requirements. If they do, proceed to step S5. If not, proceed to step S10;
S5: checks the difference in water pressure in both the input and output ends of the hollow fiber membrane filter to evaluate whether or not a clog exists. When the output end detects a lower water pressure than the input end, then it can be assumed that a clog is slowing down the filtration process and lowering water pressure. The system then proceeds to step S6;
S6: compares the differences in water pressure, if there exists any difference, and decides whether or not the system needs to clean the hollow fiber membrane filter. The system does not activate a cleaning sequence whenever a difference is detected, which is when the system proceeds to step S15. If a large difference is detected, proceed to step S7;
S7: is a cleaning sequence that begins if and only if irrigation is not needed in any part of the soil. This step is less common than step S15, but is more essential to the entire system as a whole. Water will be supplied into the system until three seconds after the hollow fiber membrane filter 22 is cleaned, unless there is not enough water to complete the cleaning sequence. If irrigation is needed, then the irrigation sequence will override the current one;
S8: closes certain valves in the valve system 222, and is always the final function that is automatically performed. The system will then proceed to step S1, given that step S9 is not activated;
S9: a response to step S4, and begins to identify the specific areas that require irrigation. The primary distribution pipes should branch out in different directions that maximizes soil coverage without the need for the user to install extra distribution pipes. However, the preferred angle of installation is 90 degrees, since it virtually divides the land into four quadrants, which can make the irrigation process easier as one specific quadrant can be identified;
S10: checks the clean water tank 23 to see if there is any water remaining. If there is no detectable water, proceed to step S13. If there is water, proceed to step S11. This positive response will be initiated independent of the actual amount of water contained within, even there is very little water remaining. The control panel 53 is programmed to place this route as its primary route, whilst other functions are not as important to the irrigation system, functionality wise;
S11: opens the designated irrigation valves that are specific to the quadrant that it is delivering water to. If there are multiple open pathways, the water will naturally divide evenly without priority to any path;
S12: transports water and irrigates the soil until the moisture detection devices 75 return a good reading, or until the system is forcefully stopped as a result of a lack of water in the clean water storage tank 23. When the system eventually stops, proceed to step S8;
S13: is a response to step S10, which opens the tap water supply valve 61 to receive water when the clean water storage tank 23 needs to be recharged with water to resume its activities. After the tank is fully recharged, it cycles back to step S9 so that the irrigation cycle may resume as normal;
S14: is a response to step S6 that begins if and only if irrigation is not needed in any part of the soil, and that the hollow fiber membrane filter 22 does not require cleaning. This function is performed under the assumption that there exists a residential water delivery pipe, which is preferable. Otherwise, this sequence must be terminated manually by the user so the function may be redirected to step S1, the path of which is not shown;
S15: follows step S14 by supplying water to the residence/building 6 until steps S1 to S4 detects that irrigation is needed again. This water is potable and may be used for many purposes, such as washing, cooking, hygiene, drinking, etc. This is a highly efficient way of balancing water usage in arid areas, as the control panel 53 may be programmed to the user's wishes. After the supply is stopped, the programs proceeds to step S8, where the entire system cycles back to step S1;

9. A valve control system as in claim 8, wherein the valve opening sequences further comprises:
When water enters the system from the rainwater collection system 31, the valve opened by default is the untreated water flow valve 222a, whilst other valves are performing automatic functions as outlined in FIG. 7. Valve 222f also opens to allow water to enter the clean water storage tank 23. This valve opening does not affect any other valve, nor will it be closed, until the system requires the hollow fiber membrane filter 22 to be cleaned. It continuously supplies water through the filter into the clean water storage tank 23 to keep as much water present as possible in the tank;
When water is being redelivered back into the hollow fiber membrane filter 22, the clean water storage tank 23 pumps water through the water pump 231. Valves 222b and 222d are opened, whilst all other valves are closed so that the wastewater that is generated from the cleaning can be safely disposed in the manual disposal valve 232. This is referenced in step S7 in FIG. 7;
When water is being delivered to the rainwater irrigation pipes 1, the clean water storage tank 23 supplies water through valves 222a and 222c. All other valves are closed so that the water supply can be dedicated to irrigation purposes. This is referenced in step S12 in FIG. 7;
When water is received from the tap water supply pipe 61 into the clean water storage tank 23, valves 222a and 222g are opened. All other valves are closed until the tank is full to ensure that the system can resume its functionality properly. This is referenced in step S13 in FIG. 7;
When water is being delivered to the residence/building 6, the water pump 231 pumps water from the clean water storage tank 23. Valves 222a and 222e are opened, whilst all other valves are closed so that the water supply can be dedicated for the user. This is referenced in step S15 in FIG. 7;
Wherein all aforementioned water valves 222 are electrically powered by solar panels 5;
Wherein all aforementioned water valves 222 further comprises:
(1) Valve 222a is the untreated water flow valve that opens to allow water to flow into the hollow fiber membrane filter 22;
(2) Valve 222b is the wastewater disposal valve that opens to allow wastewater to exit the system after the hollow fiber membrane filter 22 is cleaned;
(3) Valve 222c is the irrigation valve that opens whenever moisture detection devices 75 detect a sufficient lack of water in the soil;
(4) Valve 222d is the water pump valve that opens to allow clean water to be pumped back into the hollow fiber membrane filter 22 for cleaning;
(5) Valve 222e is the residential water delivery valve that opens to allow clean water to be pumped into the residence/building 6;
(6) Valve 222f is the clean water entry valve that opens to allow clean water to enter the clean water storage tank 23;
(7) Valve 222g is the tap water supply valve that opens to allow clean water to enter the clean water storage tank whenever the tank is empty.
